(19) United States
(12) Patent Application Publication
(10) Pub. No.: US 2023/0091750 A1
(43) Pub. Date: Mar. 23, 2023

(54) METHOD OF UTILIZING DISPERSANT CHEMICAL COMBINED WITH NANOBUBBLES AND AGITATION FOR ACCELERATED DEWATERING AND OIL STRIPPING OF TAILINGS

(71) Applicant: Crosswind Resources Inc., Calgary (CA)

(72) Inventors: Angela Vandeponseele, Calgary (CA); James Randall Clark, Calgary (CA); William Clay Baten, Midland, TX (US)

(21) Appl. No.: 17/479,756

(22) Filed: Sep. 20, 2021

(51) Int. Cl. E21B 43/34; B01D 17/02; B01D 17/04

(52) U.S. Cl. CPC E21B 43/35; B01D 17/0205; B01D 17/047

(57) ABSTRACT

A process of dewatering oil sands/coal tailings includes generating nanobubble water, mixing a chemical dispersant into the nanobubble water to form a nanobubble-dispersant mixture, adding tailings to the nanobubble-dispersant mixture to form a nanobubble-dispersant-tailings mixture, and agitating the nanobubble-dispersant-tailings mixture to form an agitated nanobubble-dispersant-tailings mixture having a solid portion and a liquid portion. The solid portion is thereafter separated from the liquid portion. The agitation may be a centrifugal motion or shaking motion to agitate the nanobubble-dispersant-tailings mixture The chemical dispersant may be sodium hydroxide dispersant for asphaltenes and the volume of the tailings added may be substantially equal to the volume of the nanobubble water generated. An oil layer may further be skimmed off the liquid portion a polymer clarifier may also be added to the liquid portion. The process may be applied to achieve accelerated tailings processing for rapid and economic environmental remediation.

### BACKGROUND OF THE INVENTION

### (1) Field of the Invention

The invention pertains generally to remediation of tailings. More specifically, the invention relates to a process and system for dewatering and oil stripping of tailings.

### (2) Description of the Related Art

Tailings, a by-product of the heavy oil mining industry, are a mixture of water, fines, various chemicals such as heavy metals, and some residual hydrocarbons. The extraction and cleaning of solids is a major issue that the oil industry faces in tailings treatment due to cost and lengthy time requirements.

Currently in industry, different methods are being used to extract the oil and water from the tailings. The most common methods include gravity settle, thin lift drying, the use of flocculants, and centrifugal forces. Each method follows guidelines as set by the Alberta Energy Regulators (AER) and Canada's Oil Sands Innovation Alliance (COSIA). Directive 085 is a Canadian standard that Albertan companies must meet, stating that within 10 years of a project's completion, the land used for tailings ponds must be reclaimed. Previously, Directive 074 was to be enforced with more stringent regulations, but companies were unable to meet remediation and reclamation targets. Unenforceable legislation created moral, social, economic, and environmental conflicts.

One method to separate tailings is to simply let the tailings gravity settle in tailings ponds. This has several disadvantages. For one, a huge amount of time is required, in some cases over a hundred years. Large areas of land for settling ponds are necessary and the ponds pose an environmental hazard and can harm surrounding ecosystems. The residual hydrocarbons are not removed in this process, so the resulting solids are still contaminated and thus considered hazardous material. Lastly, large volumes of water freeze in Northern Alberta, limiting the available settling time.

Thin lift drying involves additives that bind these tailings solids together and then thinly spreading them on the ground. This encourages rapid drying, and further layers can be added. This application is appropriate for thickened tailings (TT), composite tailings (CT) and nonsegregated tailings (NST) and involves adding sand and a coagulant to tailings.

Flocculants are commonly used so that the fine particles clump together, making them larger and easier to remove. While this is effective to some degree, operators claim the targeted separation of 70% solids w/w has not been achieved with an accelerated method. Additionally, residual hydrocarbons mean the dewatered tailings are still hazardous materials.

Another method incorporates flocculant chemicals and centrifuging the tailings after the flocculant is added to stick the small particles together. The centrifuge separates the tailings into emulsions. During this separation, several layers are made. The heaviest particles, such as sand, are on the bottom, and the fines (silts) and ultra-fines (clays) begin to concentrate above that. Critical issues include water entrapped in the fines, more than 30% weight by weight (w/w) separation is difficult at this concentration, the tailings reach a sludge or jelly like state where further drying is limited. The solution that contains this 30% w/w of solids are referred to as mature fine tailings (MFT). Tailings with less than 30% solids w/w are called fluid fine tailings (FFT).

Other methods include water capped tailings and Suncor's Permanent Aquatic Storage Structure (PASS).

According to a Canadian government agency, Alberta Energy Regulator (AER), industry requires “65 percent solids content by weight, based on deposit sampling, within one year of treated fluid tailings placement”. This amount of separation allows the solids to be reused elsewhere.

Issues currently within industry include the effectiveness, timeliness, and cost of each of these processes. Current oil sands tailings remediation treatment processes take large amounts of time, space, and resources. A common problem with each of these methods is how to efficiently extract the smaller particles within the tailings ponds, mainly the particles smaller than 44 microns.

In short, tailings treatment is presently a challenge for mining industries and oil sands operators. Acceleration of the cleaning process is of great interest.

### BRIEF SUMMARY OF THE INVENTION

According to an exemplary embodiment of the invention there is disclosed a process of utilizing a dispersant chemical combined with nanobubbles to treat tailings in an accelerated dewatering and oil stripping process for rapid and economic environmental remediation.

According to an exemplary embodiment of the invention there is disclosed a method of dewatering tailings. The method includes generating a plurality of nanobubble water, mixing a chemical dispersant into the nanobubble water to form a nanobubble-dispersant mixture, adding a plurality of tailings to the nanobubble-dispersant mixture to form a nanobubble-dispersant-tailings mixture, agitating the nanobubble-dispersant-tailings mixture to form an agitated nanobubble-dispersant-tailings mixture having a solid portion and a liquid portion, and separating the solid portion from the liquid portion.

According to an exemplary embodiment of the invention there is disclosed a system for dewatering tailings. The system includes a nanobubble water generator, a storage unit storing therein a chemical dispersant, an agitator, a separator, a plurality of electrically-controllable actuators, and a controller coupled to the electrically-controllable actuators. The nanobubble water generator generates a plurality of nanobubble water. The controller controls one or more of the electrically-controllable actuators to mix an amount of the chemical dispersant from the storage unit into the nanobubble water to form a nanobubble-dispersant mixture. The controller further controls one or more of the electrically-controllable actuators to add a plurality of tailings to the nanobubble-dispersant mixture to form a nanobubble-dispersant-tailings mixture. The controller further controls the agitator to agitate the nanobubble-dispersant-tailings mixture to form an agitated nanobubble-dispersant-tailings mixture having a solid portion and a liquid portion. The controller further controls the separator to separate the solid portion from the liquid portion.

According to an exemplary embodiment of the invention there is disclosed a non-transitory processor-readable medium comprising processor executable instructions that when executed by one or more processors cause the one or more processors to control an automated system for dewatering tailings to perform steps of generating a plurality of nanobubble water, mixing a chemical dispersant into the nanobubble water to form a nanobubble-dispersant mixture, adding a plurality of tailings to the nanobubble-dispersant mixture to form a nanobubble-dispersant-tailings mixture, agitating the nanobubble-dispersant-tailings mixture to form an agitated nanobubble-dispersant-tailings mixture having a solid portion and a liquid portion, and separating the solid portion from the liquid portion.

It is an advantage of certain embodiments disclosed herein that combining a gas infused aqueous solution with a multipurpose sodium hydroxide dispersant for asphaltenes results in rapid remedial treatment for separation of tailings wastes.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 illustrates a block diagram of a system for dewatering oil sands tailings according to an exemplary embodiment.

FIG. 2 illustrates a block diagram of the controller and associated electrical control aspects of the processing system of FIG. 1.

FIG. 3 shows a flowchart of a method of dewatering oil sands tailings according to an exemplary embodiment.

FIG. 4 illustrates a block diagram of equipment and a manual process for dewatering oil sands tailings according to an exemplary embodiment.

FIG. 5 illustrates a side view of a test tube holding agitated nanobubble-dispersant-tailings mixture as was observed during testing.

FIG. 6 illustrates a chart comparing percent water separation over time lapsed obtained for different tests.

### DETAILED DESCRIPTION

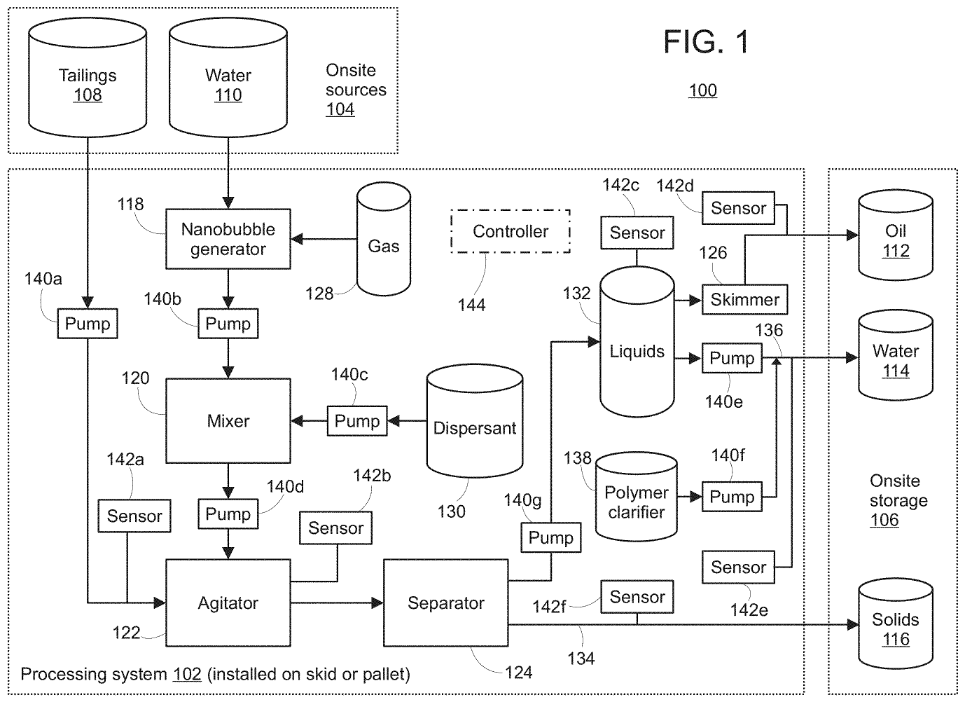

FIG. 1 illustrates a block diagram of a system 100 for dewatering oil sands tailings according to an exemplary embodiment. The system 100 is installed at an oil sands facility and includes an automated processing system 102 installed on a skid or pallet coupled to a plurality of onsite sources 104 and a plurality of onsite storage tanks 106. The onsite sources 102 include tailings 108 to be treated along with water 110, which are the two primary inputs of the processing system 102. The onsite storage 106 includes an oil tank 112, water tank, and solids tank (or other types of storage containers besides tanks) for storing output of the processing system 102.

The skid or pallet mounted processing system 102 includes a nanobubble generator 118, a mixer 120, an agitator 122, a separator 124, and a skimmer 126. A gas storage tank 128 and/or an air compressor is coupled to the nanobubble generator 118 and a dispersant tank 130 is coupled to the mixer 120. The separator 126 has two outputs including a liquids storage tank 132 and a solids output pipe 134 that leads to the onsite solids storage tank 116. The liquids storage tank 132 has a water output pipe 136 to which a polymer clarifier storage tank 138 is attached for adding a polymer clarifier to the water output 136 for mixing and storage within the onsite water storage tank 114.

The processing system 102 further includes a plurality of pumps 140 including a tailings input pump 140a, a nanobubble water pump 140b, a dispersant injection pump 140c, a mixer output pump 140d, a liquids output pump 140e, a polymer clarifier pump 140f, and a separator liquid output pump 140g. A plurality of sensors 142 are also disposed within the processing system 102 including a tailings input sensor 142a, an agitator sensor 142b, a liquids tank sensor 142c, a skimmer output sensor 142d, a liquids output sensor 142e, and a solids output sensor 142f. A controller 144 being an embedded computer system in this embodiment is provided for controlling pump 140 and other device 118, 120, 122, 126, 126 operation according to sensor data received from the various sensors 142.

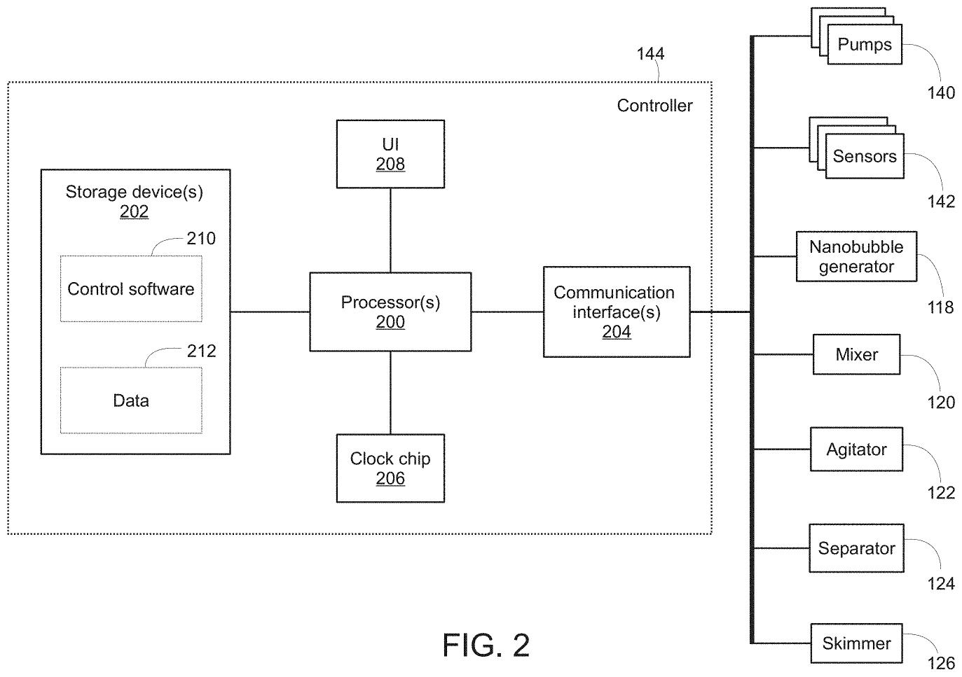

FIG. 2 illustrates a block diagram of the controller 144 and associated electrical control aspects of the processing system 102 of FIG. 1. As illustrated, the controller 144 is a microcontroller including one or more processors 200 coupled to one or more storage devices 202, one or more communication interfaces 204, a clock chip 206 and a user interface (UI) 208. The communications interfaces 204 are in term coupled to the various electrically controllable devices 118, 120, 122, 124, 126, actuators 140 and sensors 142 described above with reference to FIG. 1. The processors 200 execute software instructions provided by control software 210 stored in the storage devices 202 to control the various devices 118, 120, 122, 124, 126 and actuators 140 within the processing system 102.

The UI 208 may comprise elements such as light emitting diodes and/or touchscreen or other well-known display and input types allowing an operator to interact with the controller 144 as needed. The clock chip 206 is a real time clock chip allowing the processors 200 to accurately track time and trigger events and process steps based on the passage of time. The communication interfaces 204 include wired and wireless transceivers for communication with devices outside of the controller 144. Lastly, sensor and other data 212 is stored within the storage devices 202 and is utilized by the processors 200 when executing the control software 210. Although not illustrated in FIG. 2, additional types of communication interfaces 204 and/or components coupled thereto may be provided. For instance, a connection port such as a serial port, Ethernet port, Wi-Fi access point (AP), or a USB port may be coupled to the processors 200 via the communication interfaces 204 in order to allow an operator's laptop or other device to act as the UI 208 or an additional UI for interacting with the controller 144.

The one or more processors 200 may be included in a central processor unit (CPU) of a computer server or other embedded computing device acting as the controller 144. In the following description the plural form of the word “processors” will be utilized as it is common for a CPU of a computer server or embedded device to have multiple processors (sometimes also referred to as cores); however, it is to be understood that a single processor 200 may also be configured to perform the described functionality in other implementations.

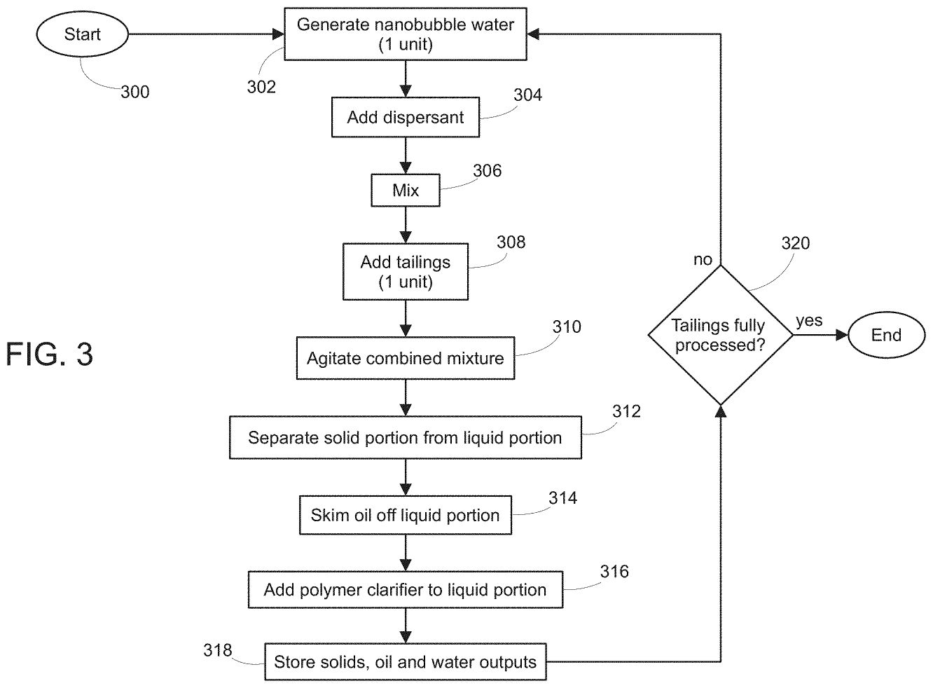

FIG. 3 shows a flowchart of a method of dewatering oil sands tailings according to an exemplary embodiment. The steps of FIG. 3 may be performed automatically by the processing system of FIG. 1 under control of the controller. The steps of the flowchart are not restricted to the exact order shown, and, in other configurations, shown steps may be omitted or other intermediate steps added.

At step 300 the process starts, typically in response to an operator initiating processing operations such as by pressing a button or otherwise interacting with the UI 208.

At step 302, nanobubble water is generated. In this embodiment, the controller 144 commands the nanobubble generator 118 to begin generating a predetermined amount (i.e., volume) of nanobubble water. The predetermined amount can be any amount desired volume depending on the sizes of the mixer 120, agitator 122, separator 124 and liquids storage tank 132 on the processing system 102 skid. As the ratio of nanobubble water to other components is helpful to control, the amount of nanobubble water generated is referred to herein as one unit, where the unit may be any number of litres (or millilitres), as desired.

In some embodiments, the nanobubble generator 118 is an off-the-shelf device such as manufactured and sold by Moleaer Inc. The gas add rate from the gas storage tank 128 may be configured to in the range of 0.25 to 1.5 standard cubic fee per hour (SCFH). For instance, in some embodiments, the gas is nitrogen (N2) or compressed air and the gas add rate is set to 0.5 SCFH average. Operating pressures may be approximately 110 pounds per square inch (PSI) with the water at 20 PSI. The water 110 inputted into the nanobubble generator 118 will be clear whereas the nanobubble water outputted by the generator 118 will be opaque when filled with nano bubbles (for example, approximately 500 million bubbles per litre in some embodiments).

At step 304, chemical dispersant is added into the nanobubble water to form a nanobubble-dispersant mixture. In this embodiment, the controller 144 commands the nanobubble water pump 140b to pump the generated nanobubble water into the mixer 120. The controller 144 further commands the dispersant injection pump 140c to pump a predetermined amount of the dispersant chemical into the mixer 120 for mixing with the nanobubble water.

The chemical dispersant in preferred embodiments contains sodium hydroxide. This may be achieved using a sodium hydroxide dispersant for asphaltenes that is protein-based and water soluble. Beneficially, in preferred embodiments, the chemical dispersant is further non-toxic, non-volatile, non-flammable, and biodegradable.

Two examples of chemical dispersant that may be utilized at step 304 are the Asphaltene Dispersants with product codes BC-1 and BC-3 sold by distributor SGB Solutions, LP. Of these two options, improved results with better separation times and better chemical properties were obtained during testing utilizing the BC-3 chemical. For this reason, in some embodiments, the chemical dispersant added by the controller at step 304 is the BC-3 chemical by distributor SGB Solutions, LP.

The controller 144 commands the dispersant injection pump 140c to add a predetermined concentration of the chemical dispersant, where the amount in some embodiments is controlled by the controller 144 driving the dispersant injection pump 140c to pump in dispersant in a range of 0.5% to 5% of the total volume of mixed nanobubble water and tailings (see step 308, described below, where the tailings are added). This range can vary depending on economics and how fast the reaction is required. In particular, the broad range 0.5% to 5% is given for flexibility depending on whether economics is the primary constraint or if reduced time is the primary objective. A narrow range of application from 0.5% to 1.0% is lower cost while still providing acceleration benefits, albeit not as much as higher concentrations. Likewise, higher concentrations in the range of 4%-5% provides for rapid separation with some increased costs. The concentration level may be adjusted and/or selected by users according to their preference for keeping costs lower or for accelerating the separation process.

At step 306, the nanobubble water and chemical dispersant are mixed. The controller 144 drives the mixer 120 to mix the nanobubble water and chemical dispersant together to form a nanobubble-dispersant mixture. In some embodiments, the mixing processes is performed under the pressure of the compressed gas 128 utilized by the nanobubble generator 118. This may be achieved by ensuring the output of the nanobubble generator 118 and input and mixing portions of the mixer 120 are pressure sealed.

At step 308, tailings are added. The controller 144 drives the tailings input pump 140a to move a predetermined amount of the tailings 108 into the agitator 122 while simultaneously driving the mixer output pump 140d to move the generated nanobubble-dispersant mixture into the agitator 122 as well. The combination of the tailings and the nanobubble-dispersant mixture is referred to herein as the nanobubble-dispersant-tailings mixture.

In some embodiments, the controller 144 ensures that the tailings input pump 140a adds a predetermined amount of the tailings 108 where the predetermined amount of tailings 108 is substantially equal to the predetermined amount of nanobubble water that was generated by the nanobubble water generator 118 at step 302. For example, assuming one litre of nanobubble water was generated at step 302, then a corresponding one litre of tailings 108 is added to the nanobubble-dispersant mixture at step 308. The dispersant concentration within the resulting nanobubble-dispersant-tailings mixture is maintained by the controller 144 to be within the range of 0.5% to 5%.

At step 310, the controller 144 activates the agitator 122 to agitate the nanobubble-dispersant-tailings mixture to form an agitated nanobubble-dispersant-tailings mixture. The agitation performed by the agitator 122 may be a simple mixing similar to the mixer 120. For instance, in some embodiments, the agitator 122 may be omitted as a separate component and the tailings 108 may simply be added into the mixer 120 for mixing. However, in performed embodiments, the agitator 122 is different than the mixer 120 and utilizes a centrifugal motion or shaking motion to agitate the nanobubble-dispersant-tailings mixture (instead of a stirring motion as used by the mixer 120).

A benefit of the centrifugal or shaking motions combined with the nanobubble-dispersant-tailings mixture is to encourage separation and extraction of solids, oil and water. The chemical dispersant disrupts the hydrocarbon-hydrocarbon solubility interaction in crude oil and the nanobubbles break apart oil and solids more efficiently than plain water. The bubbles change the density of water and create gas saturation, causing oil to separate and rise. The agitation combined with the nanobubbles and dispersant beneficially yields the ability to reduce overall crude viscosity as the dispersant penetrates and absorbs onto tailings, thus permitting rapid removal of heavy oil and water clinging to tailings solids. The result of the agitation is the formation of an agitated nanobubble-dispersant-tailings mixture having a solid portion and a liquid portion. The stripped solids gravity-settle to the bottom when the agitation is a back and forth or up and down motion, or under centrifugal motion settle to the outward spinning “bottom” of the rotating frame of reference.

At step 312, the solid and liquid portions of the agitated nanobubble-dispersant-tailings mixture are removed from one another. This is done by the controller 144 activating the separator 124 to scrape the solid portion away from the agitator 122 and activating the separator output pump 140g to pump the liquid portion into the liquids storage tank 132.

At step 314, an oil layer is skimmed off the liquids portion. The controller 144 measures the amount of an oil layer on the stored liquid using the liquids tank sensor 142c and activates the skimmer 126 to move the oil into the external oil storage tank 122. The separated oil skimmed off in this manner may be sold for an additional revenue stream. At step 314, the controller 144 further activates the liquids output pump 140e in order to move the water portion into the external water storage tank 144.

At step 316, the controller 144 activates the polymer clarifier pump 140f in order to add polymer clarifier into the water storage tank 114 to help make it easier to later remove any remaining suspended particles in the outputted water.

At step 318, the oil portion, water portion, and solid portions are stored within the respective onsite storage tanks 112, 114, 116. These tanks 112, 114, 116 may be monitored by additional sensors and an alert may be sent by the controller 144 to a worker's mobile device in response to the controller 144 detecting one or more of the tanks 112, 114, 116 approaching a full storage capacity.

At step 320, the controller 144 determines whether the tailings 108 are fully processed. This may be done by one or more external sensor(s) within the tailings tank 108 or by control signals passed to the controller 144 via external onsite systems that monitor the amount of tailings 108 remaining to be processed. Alternatively, the controller 144 may monitor the tailings input pump 140a to ensure that sufficient tailings are present (for example, during step 308 to ensure that sufficient tailings are added). When detecting that the input tailings are finished, this indicates that the tailings in the tailings tank 108 are fully processed and control ends; otherwise, control returns to step 302 to repeat the process for a next unit of tailings.

The process of FIG. 3 beneficially utilizes chemical dispersant such as sodium hydroxide dispersant for asphaltenes and nanobubbles combined with agitation to accelerate and efficiently separate water, oil and solids, aiding in the economic, rapid reclamation of oil sands tailings wastes. Beneficially, the process of FIG. 3 may be fully automated in some embodiments using a system 100 such as that described in FIG. 1 or may also be performed manually or with partial automation in other embodiments.

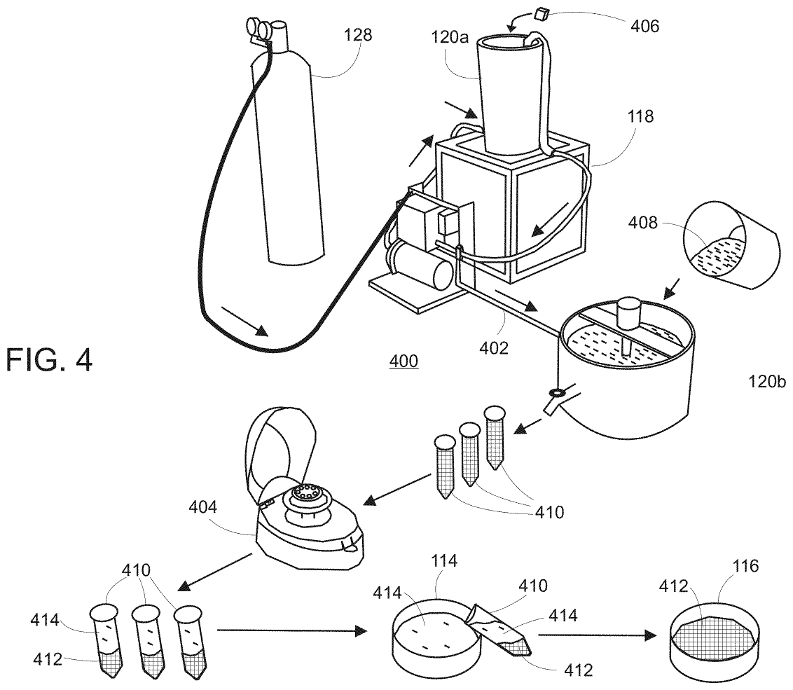

FIG. 4 illustrates a block diagram of a system 400 and a manual process for dewatering oil sands tailings according to an exemplary embodiment. Similar parts have similar function as described above in FIG. 1 are given the same reference numerals for consistency. The system 400 includes a gas storage container 128, a nanobubble generator 118, a first mixer 120a in a feedback loop with the nanobubble generator 118, a second mixer 120b coupled to an output 402 of the nanobubble generator 118, a centrifuge 404 operating as an agitator 122, and water and solids storage tanks 114, 116. The combination of the nanobubble generator 118 and the first mixer 120a acts as a nanobubble recirculation unit where the dispersant chemical 406 is added to the first mixer 120a for remixing with the nanobubble water being generated under pressure within the nanobubble generator 118. The system 400, equipment and process illustrated in FIG. 4 was utilized by the inventors for small scale testing during approximately two years of development.

The testing procedure involved the following steps. A pump of the nanobubble generator 118 was primed to remove air and the hoses were filled with fluid to create suction on the discharge side 402 to pull water thru the pump. The water was circulated back to first mixer 120a until air was gone and lines and pump were fluid filled.

Compressed air or N2 was added at approximately 1.2 SCFH average. Operating pressures were held around 110 PSI and water at 20 PSI. Tap water was utilized as an input to the nanobubble water generator 118 and it was observed visually that the water became opaque when filled with nano bubbles.

During a first testing step, a 25 ml amount of nanobubble water was generated for testing purposes (i.e., 1 unit=25 ml). Different concentrations of sodium hydroxide dispersant for asphaltenes were then added to the 25 ml of nanobubble water for different tests in a range of 0.5% to 5%. A syringe was utilized to add the chemical dispersant 406 during testing.

During a second testing step, 25 ml of stirred tailing sample 408 was obtained and added to the nanobubble-dispersant mixture formed in step one at the second mixer 120b. The resultant nanobubble-dispersant-tailings mixture was then mixed in the second mixer 120b and agitated in separate test tubes 410 utilizing the centrifuge 404.

After centrifuging, the test tubes 410 showed the agitated nanobubble-dispersant-tailings mixture had distinct solid and liquid portions 412, 414, which were manually separated into the solid and liquid storage tanks 114, 116, respectively.

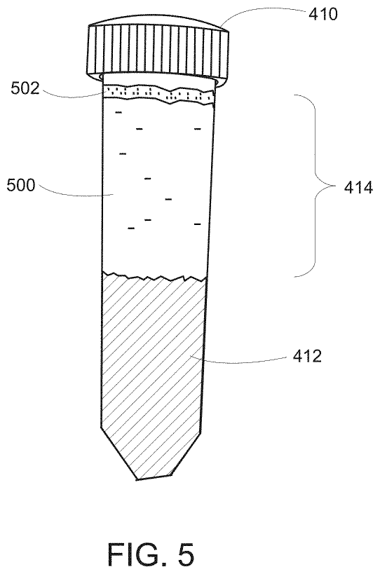

FIG. 5 illustrates a side view of a test tube 410 holding agitated nanobubble-dispersant-tailings mixture as was observed during testing. As illustrated, the agitated nanobubble-dispersant-tailings mixture includes a solid portion 412 at the bottom and a liquid portion 414 above. The liquid portion 414 is actually comprised of a water portion 500 in the middle and a thin oil layer 502 along the top. It is this oil layer that is removed by the skimmer as described above for step 314 of FIG. 3.

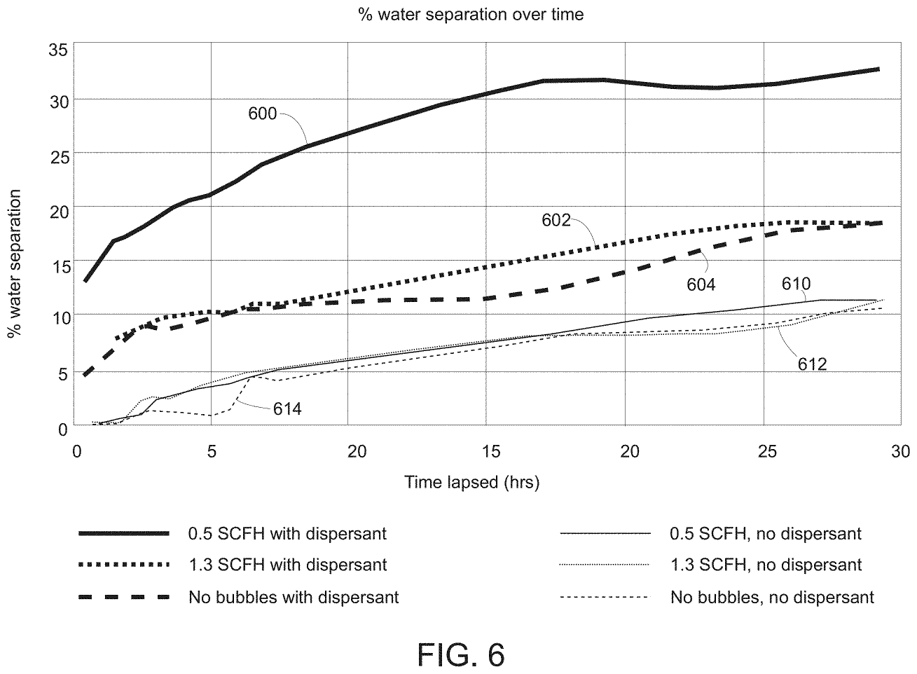

FIG. 6 illustrates a chart comparing percent water separation over time lapsed obtained for different tests. Six tests are illustrated, where each test is represented by a different style line utilized on the chart.

The three thicker lines illustrate the results of the above testing procedure with a same amount of chemical dispersant (i.e., 0.5% BC-3) added but comparing different gas flow rates for generating the nanobubble water or with just tap water instead of nanobubble water. Specifically, the thick solid line 600 shows 0.5 SCFH with dispersant, the thick dotted line 602 shows the results with 1.3 SCFH with dispersant, and the thick dashed line 604 shows tap water with dispersant but no nanobubbles.

The three thinner lines represent the results of the above testing procedure with no chemical dispersant added for the same three different gas flow rates for generating the nanobubble water and tap water. Specifically, the thin solid line 610 shows 0.5 SCFH without dispersant, the thin dotted line 612 shows the results with 1.3 SCFH without dispersant, and the thin dashed line 614 shows tap water without dispersant.

As illustrated, significantly reduced time is required to obtain separations from utilizing nanobubble water generated with 0.5 SCFH with dispersant. In particular, at 0.5 SCFH, 30% water separation was achieved after only approximately 15 hours.

In exemplary embodiments, a sodium hydroxide chemical such as a sodium hydroxide dispersant for asphaltenes is combined with nanobubble water and tailings. The nanobubble-dispersant-tailings mixture is agitated for a period of time to form an agitated nanobubble-dispersant-tailings mixture having a solid portion and a liquid portion. The solid portion is separated from the liquid portion, and a liquid oil layer may further be separated from a liquid water layer thereby outputting a solid portion, an oil portion, and a water portion.

Beneficially, the above-described systems 100, 400 and processes may be applied to achieve accelerated oil sands tailings processing to dewater and oil strip tailings for rapid and economic environmental remediation. The nanobubbles and chemical dispersant greatly accelerate oil sands tailings dewatering as well as oil separation from solids. The combined chemical and mechanical process illustrated here beneficially speeds up the settling and separation rate for tailings while also liberating greater than 70% of both the oil and water extracted. This addresses other issues, including environmental, operational, and economic hurdles.

In exemplary embodiments, the above-described mechanical process pumps various water and tailings inputs for combination with the chemical dispersant and agitation to help solve current tailings separation, extraction, and remediation issues. Beneficially, processes disclosed herein extract both water and oil from tailings solids; rapidly and substantially. The sodium hydroxide dispersant for asphaltenes and nanobubble research methods included experimentation, numerous sample generation with varying combinations of chemicals and bubbles used with different operator tailing waste samples.

According to an exemplary embodiment, sodium hydroxide dispersant for asphaltenes mixed with nanobubble water utilizes predominately existing equipment and processes such as mixers, separators, skimmers, pumps and sensors. The sodium hydroxide dispersant for asphaltenes helps strip the oil from the suspended tailings particles and allow solids down to 1 micron to be freed from the tailings emulsions. Concentrations of sodium hydroxide dispersant for asphaltenes found to be particularly effective range from 0.5%-5%. Within that broad range, a first narrower range of 0.5%-1% concentration is ideal economically, and a second narrower range of 4%-5% is optimum concentration for rapid separation. Bubbles are generated via a nanobubble generator and added as a method of increasing reaction speed and particle settling. These bubbles are smaller than 1 micron in diameter and possess a variety of properties which accelerates oil flotation, particle flocculation, and particle settling.

In some embodiments, using sodium hydroxide dispersant for asphaltenes as a dispersant chemical with nanobubble water and an efficient mixing process, separation and extraction of oil and water greater than 70% from oil sands tailings solids can be achieved. Beneficially, the dispersant chemical such as sodium hydroxide dispersant for asphaltenes can be protein-based water soluble, nontoxic, nonvolatile, nonflammable, and biodegradable chemical. The asphaltene dispersant provides the ability to disrupt the hydrocarbon-hydrocarbon solubility interaction that forms crude oil, reduces overall crude viscosity and acts as an inhibitor as it penetrates solids.

In some embodiments, the nanobubbles (including a class of microbubbles), are extremely small gas bubbles, in aqueous solutions and have the ability to change the normal characteristics of water. Nanobubbles have several unique physical properties, such that they can remain suspended in water for months, traveling randomly throughout the body of water and efficiently aerating the entire water system and are added at about 1-1.5 standard cubic feet (scf).

Nanobubbles combined with asphaltene dispersant break apart oil and solids and separate water more efficiently. Discrete layers formed in minutes incorporate solids on the bottom, water in the middle, and an oil layer on top. More nanobubbles change the density of water and create gas saturation causing oil to rise and be skimmed off, and allowing solids to fall to bottom for reclamation.

The aforementioned cocktail of sodium hydroxide dispersant for asphaltenes and nanobubble water beneficially accelerates the cleaning and settling of particulates in oil sands tailings, dewatering, and oil removal. Current technology is ˜35% water removal from solids and requiring weeks of time. Utilizing the process disclosed herein, >70% water and oil may be removed from solids and is happening in days.

Varying concentrations of dispersant chemical and nanobubble water can be used to shorten reaction time. Different ratios of asphaltene dispersant and nanobubbles were investigated and all successfully separated tailings into layers. Certain combinations such as the nanobubble water at 0.5 SCFH and sodium hydroxide dispersant for asphaltenes within concentrations from 0.5% to 5% provided further accelerated separation times.

The application of chemical dispersant and nanobubble water can be mixed with tailings qualities in a 50:50 ratio (i.e., 1 unit of each). This process can use existing equipment and existing set up, for simplicity and efficiency.

A testing process included a nanobubble machine, a fresh-water feed source, a chemical dispersant addition station, and a manual mixing process. Visual results during testing demonstrated discrete separation of oil droplets (often adhered to the surface of the beaker as well as floating on top), separation of water (seen in layer), and separation of solids (in bottom of beaker); within 5-15 minutes depending on the concentration of dispersant added.

Beneficial results may be obtained according to the processes disclosed herein with the ability to remove at least 70% of water and oil trapped/adhered to the tailings solids.

In an exemplary embodiment, a process of dewatering oil sands/coal tailings includes generating a plurality of nanobubble water, mixing a chemical dispersant into the nanobubble water to form a nanobubble-dispersant mixture, adding tailings to the nanobubble-dispersant mixture to form a nanobubble-dispersant-tailings mixture, and agitating the nanobubble-dispersant-tailings mixture to form an agitated nanobubble-dispersant-tailings mixture having a solid portion and a liquid portion. The solid portion is thereafter separated from the liquid portion. The agitation may be a centrifugal motion or shaking motion to agitate the nanobubble-dispersant-tailings mixture The chemical dispersant may be sodium hydroxide dispersant for asphaltenes and the volume of the tailings added may be substantially equal to the volume of the nanobubble water generated. An oil layer may further be skimmed off the liquid portion a polymer clarifier may also be added to the liquid portion. The process may be applied to achieve accelerated tailings processing for rapid and economic environmental remediation.

Although the invention has been described in connection with preferred embodiments, it should be understood that various modifications, additions and alterations may be made to the invention by one skilled in the art without departing from the spirit and scope of the invention. For example, although the above description has focused on dewatering and oil stripping of oil sands tailings, a similar process may be utilized in the processing of other types of tailings such as coal mining tailings.

Although FIG. 1 described above shows specific pump and sensor locations, other or different pumps, sensors, and locations thereof may be utilized in other embodiments. Further, different types of electronically controllable actuators in addition to or instead of pumps such as valves and conveyers for solids may also be utilized as needed to control flow and injection of liquids and removal of solids in different embodiments.

The above-described functionality of the controller may be implemented by software executed by one or more processors operating pursuant to instructions stored on a tangible computer-readable medium such as a storage device to perform the above-described functions of any or all aspects of the controller. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the controller or any of the above-described modules as a result of executing the instructions.

In other embodiments, rather than being software modules executed by one or more processors, the controller functionality may be implemented as hardware modules configured to perform the above-described functions. Examples of hardware modules include combinations of logic gates, integrated circuits, field programmable gate arrays, and application specific integrated circuits, and other analog and digital circuit designs.

Unless otherwise specified, control functionality features described may be implemented in hardware or software according to different design requirements. In addition to a dedicated physical computing device, the word “server” may also mean a service daemon on a single computer, virtual computer, or shared physical computer or computers, for example.

Functions of single units may be separated into multiple units, or the functions of multiple units may be combined into a single unit. For example, the mixer and agitator may be combined into a single mixer-agitator unit in some embodiments. Likewise, the separator and/or liquids storage and skimmer may also be incorporated into the mixer or separator in other embodiments.

All combinations and permutations of the above-described features and embodiments may be utilized in conjunction with the invention.

1. A method of dewatering tailings, the method comprising:
generating a plurality of nanobubble water;
mixing a chemical dispersant into the nanobubble water to form a nanobubble-dispersant mixture;
adding a plurality of tailings to the nanobubble-dispersant mixture to form a nanobubble-dispersant-tailings mixture;
agitating the nanobubble-dispersant-tailings mixture to form an agitated nanobubble-dispersant-tailings mixture having a solid portion and a liquid portion; and
separating the solid portion from the liquid portion.

2. The method of claim 1, wherein the chemical dispersant contains sodium hydroxide.

3. The method of claim 1, wherein the chemical dispersant is a sodium hydroxide dispersant for asphaltenes.

4. The method of claim 1, wherein the chemical dispersant is a protein-based and water soluble.

5. The method of claim 1, wherein the chemical dispersant is non-toxic, non-volatile, non-flammable, and biodegradable.

6. The method of claim 1, further comprising mixing a predetermined concentration of the chemical dispersant being in a range of 0.5% to 5% into the nanobubble water to form the nanobubble-dispersant mixture.

7. The method of claim 1, further comprising mixing the chemical dispersant into the nanobubble water under a pressure of a compressed gas.

8. The method of claim 7, wherein the compressed gas is N2 and the pressure is substantially 110 psi.

9. The method of claim 1, further comprising:
generating a predetermined volume of the nanobubble water; and
adding a volume of the tailings substantially equal to the volume of the nanobubble water generated to thereby form the nanobubble-dispersant-tailings mixture.

10. The method of claim 1, further comprising skimming an oil layer off the liquid portion.

11. The method of claim 10, further comprising, after separating the solid portion from the liquid portion and skimming the oil layer off the liquid portion, adding a polymer clarifier to the liquid portion.

12. A system for dewatering tailings utilizing the method of claim 1, the system comprising:
a nanobubble water generator;
a storage unit storing therein the chemical dispersant;
an agitator;
a separator;
a plurality of electrically-controllable actuators; and
a controller coupled to the electrically-controllable actuators;
wherein the nanobubble water generator generates the plurality of nanobubble water;
the controller controls one or more of the electrically-controllable actuators to mix an amount of the chemical dispersant from the storage unit into the nanobubble water to form the nanobubble-dispersant mixture;
the controller further controls one or more of the electrically-controllable actuators to add the plurality of tailings to the nanobubble-dispersant mixture to form the nanobubble-dispersant-tailings mixture;
the controller further controls the agitator to agitate the nanobubble-dispersant-tailings mixture to form the agitated nanobubble-dispersant-tailings mixture having the solid portion and the liquid portion; and
the controller further controls the separator to separate the solid portion from the liquid portion.

13. The system of claim 12, wherein the chemical dispersant contains sodium hydroxide.

14. The system of claim 12, wherein the chemical dispersant is a sodium hydroxide dispersant for asphaltenes.

15. The system of claim 12, wherein the chemical dispersant is a protein-based and water soluble.

16. The system of claim 12, wherein the chemical dispersant is non-toxic, non-volatile, non-flammable, and biodegradable.

17. The system of claim 12, wherein the controller further controls one or more of the electrically-controllable actuators to mix a predetermined concentration of the chemical dispersant being in a range of 0.5% to 5% into the nanobubble water to form the nanobubble-dispersant mixture.

18. The system of claim 12, wherein:
the nanobubble water generator generates a predetermined volume of the nanobubble water; and
the controller further controls one or more of the electrically-controllable actuators to add a volume of the tailings substantially equal to the volume of the nanobubble water generated by the nanobubble water generator to thereby form the nanobubble-dispersant-tailings mixture.

19. The system of claim 12, further comprising:
a skimmer for skimming an oil layer off the liquid portion; and
a polymer clarifier pump for, after separating the solid portion from the liquid portion and skimming the oil layer off the liquid portion, adding a polymer clarifier to the liquid portion.

20. A non-transitory processor-readable medium comprising processor executable instructions that when executed by one or more processors cause the one or more processors to control an automated system for dewatering tailings to perform the method of claim 1.
